(19) United States
(12) Patent Application Publication
(10) Pub. No.: US 2009/0164288 A1
(43) Pub. Date: Jun. 25, 2009

(54) Scheduling Apparatus, Scheduling Method and Recording Medium

(76) Inventor: Hiroshi Kojima, Tokyo (JP)

Correspondence Address: ARENT FOX LLP, 1050 CONNECTICUT AVENUE, N.W., SUITE 400, WASHINGTON, DC, 20036, US

(21) Appl. No.: 12/064,766

(22) PCT Filed: Aug. 24, 2006
(86) PCT No.: PCT/JP2006/317154

§ 371 Date: Feb. 25, 2008

(30) Foreign Application Priority Data
Aug. 25, 2005 (JP) 2005-244838

(51) Int. Cl. G06Q 10/00

(52) U.S. Cl. 705/8

(57) ABSTRACT

Has a resource/period management part (23) for managing resource information relating to resources and period information relating to periods having a plurality of period units associated with each other by using a table, wherein the resource/period management part (23) executes allocation of a set of the resource information and the period information and a task to be processed based on constraint conditions.

### TECHNICAL FIELD

The present invention relates to a scheduling apparatus, a scheduling method and a recording medium.

### BACKGROUND ART

Conventionally, an administrator of scheduling performs scheduling for allocating resources such as personnel or transport machines to a task by allocating a resource to a task so that various conditions regarding to scheduling match in consideration of the conditions. Such a scheduling, however, has a problem in that it is difficult for a person to quickly and precisely allocate a resource to a task in the case where it largely depends on administrator's experience and if the various conditions are complicated.

The Patent Document 1 discloses a technique relating to a worker matching system intending to allocate necessary number of workers (resource) having necessary abilities to a working site (task) at a necessary time.

As the technique described in the Patent Document 1, however, allocates workers in a short period unit, a solution space relating to allocation becomes larger, and accordingly it may increase a time of a searching process for a solution (i.e., an allocation process of a resource to a task).

[Patent Document 1] Japanese Patent Application Laid-Open No. 2002-56049

### SUMMARY OF THE INVENTION

The present invention is adapted in view of the abovementioned problems and intends to reduce a solution space relating to scheduling as much as possible.

In order to solve the abovementioned problems, the scheduling apparatus of the present invention has resource/period management means for managing resource information associated with resources and period information associated with periods consisting of a plurality of period units associated with each other by using a table, wherein the resource/period management means executes allocation of a set of the resource information and the period information and a task to be processed based on constraint conditions.

The scheduling apparatus of the present invention has resource/period management means for managing resource information associated with resources and period information associated with periods consisting of a plurality of period units associated with each other by using a table, wherein the resource/period management means executes allocation of a set of the resource information and the period information and a task to be processed based on constraint conditions so that it allocates a set of period information associated with a period including a plurality of the abovementioned period units and resource information associated with a resource to a task instead of first deciding a small period unit for starting a task and allocating a resource available till a task ends from the period unit to the task, it can reduce a solution space associated with scheduling as much as possible.

The scheduling apparatus corresponds to an information processing unit 1 to be described later or the like, for example. The resource/period management means corresponds to a resource/period management part 23 to be described later or the like. The period unit corresponds to a period unit (for example, a day) to be described later, for example. The period consisting of period units corresponds to a period to be described later, for example, (for example, a week or five days except for Saturday and Sunday from a week). The constraint conditions corresponds to “Does specialty of an examiner (for example, field information relating to examination qualifications of the ISO owned by a resource) fulfills specialty required for examined matter (for example, field information relating to a task)”, “the upper limit of moving between corporations to be examined is within four hours, for example”, “the upper limit of an examined matter for an examiner to examine in a period is within three matters, for example”, “does not allocate an examined matter which requires personnel to stay the night over the day before at the next day of absence with leave”, or the like. The period information includes information relating to a starting period unit indicating the start of the period and an ending period unit indicating the end of the period.

In order to solve the abovementioned problems, the present invention may be a scheduling method and a recording medium.

According to the present invention, a solution space associated with scheduling can be reduced as much as possible.

### BRIEF DESCRIPTION OF THE DRAWINGS

FIG. 1 is a hardware block diagram (1) of an example of an information processing unit;

FIG. 2 is a functional block diagram of an example of an information processing unit;

FIG. 3 is a conceptual diagram where a resource/period management part 23 manages resource identifying information and a period associated with each other by using a table;

FIG. 4 is a diagram (1) showing a representative frame;

FIG. 5 is a diagram (2) showing a representative frame;

FIG. 6A is a diagram showing an example of a pattern indicating an allocating state within a period;

FIG. 6B is a diagram showing data which is used by the resource/period management part to obtain a pattern number;

FIG. 7 is a diagram showing an example of pattern number information (pattern number information table);

FIG. 8 is a flowchart (1) showing an automatic allocation process;

FIG. 9 is a flowchart (2) showing an automatic allocation process;

FIG. 10 is a flowchart (3) showing an automatic allocation process;

FIG. 11 is a flowchart (4) showing an automatic allocation process;

FIG. 12 is a flowchart (5) showing an automatic allocation process;

FIG. 13 is a functional diagram (2) of an example of an information processing unit;

FIG. 14 is a conceptual diagram of a case where a task 2 is allocated to a resource 1;

FIG. 15 is a conceptual diagram of a case where the task 2 is allocated to a resource 2;

FIG. 16 is a conceptual diagram of a case where the task 2 is allocated to a resource 3;

FIG. 17 is a conceptual diagram of a case where the task 2 is allocated to a resource 4; and

FIG. 18 is a flowchart (6) showing an automatic allocating process.

### DETAILED DESCRIPTION OF THE PREFERRED EMBODIMENTS

### First Embodiment

An embodiment of the present invention will be described with reference to the drawings. In the embodiment, an example of scheduling will be described by using an examiner having one or more examination qualifications relating to the ISO as a resource and an examining matter examined by an examiner (a regular examination, an updating examination or the like) as a task. Here, for the ISO, a plurality of series such as the ISO 9000 series, the ISO14000 series and the like are present as a series, and a plurality of standards such as the ISO90001, the ISO9004, the ISO14001 and the like are present as a standard. Each standard includes a plurality of fields such as software, foods, architecture and the like corresponding to industrial classification or the like, for example. The examination qualification relating to the ISO is present according to each field of each standard.

Therefore, as an examiner having a plurality of examination qualifications, an examiner having examination qualifications in a plurality of fields (for example, software and foods) in the same standard (for example, the ISO9001) is present, or an examiner having examination qualifications in the same field (for example, software) in different standards (for example, the ISO9001 and the ISO14001) is present.

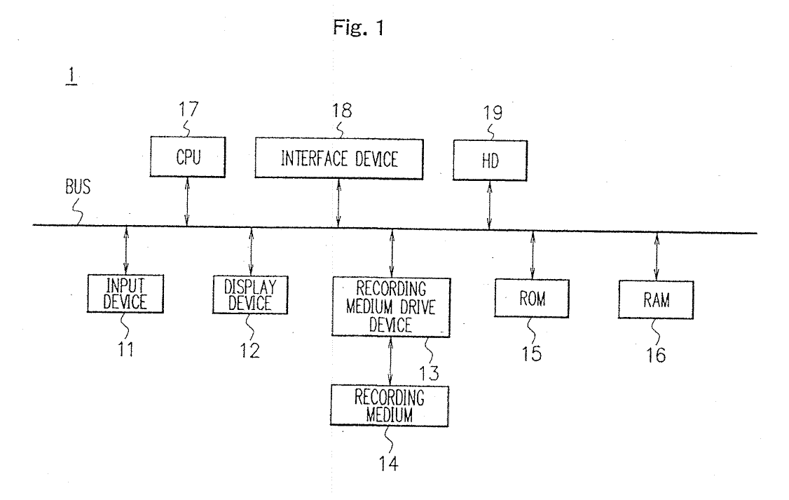

FIG. 1 is a hardware block diagram (1) of an example of an information processing unit. As shown in FIG. 1, the information processing unit 1 includes an input device 11, a display device 12, a recording medium drive device 13, a ROM (Read Only Memory) 15, a RAM (Random Access Memory) 16, a CPU (Central Processing Unit) 17, an interface device 18 and an HD (Hard Disk) 19 as hardware components.

The input device 11 consists of a keyboard, a mouse and the like for an operator (or a user) of the information processing unit 1 to manipulate, and used for inputting various types of manipulation information into the information processing unit 1. The display device 12 consists of a display and the like used by a user of the information processing unit 1, and used for displaying various types of information (or a screen) or the like. The interface device 18 is an interface for connecting the information processing unit 1 with a network or the like.

The scheduling program is provided for the information processing unit 1 by a recording medium 14 such as a CD-ROM or the like, for example, or downloaded through a network or the like. The recording medium 14 is set in a recording medium drive device 13, and a scheduling program is installed to HD 19 via the recording medium drive device 13 from the recording medium 14.

The ROM 15 stores a program or the like first read in when the information processing unit 1 is switched on. The RAM 16 is a main memory of the information processing unit 1. The CPU 17 reads out a scheduling program from the HD 19 and stores it in the RAM 16 and executes the scheduling program as required to provide some functions to be described later or execute a flowchart and the like to be described later. The HD 19 stores resource information, task information and the like to be described later, for example, other than a scheduling program. All or some of the resource information, period information, task information and the like may be stored in an HD or the like of another device connected to the information processing unit 1 via a network. For simplicity of descriptions below, the resource information, the task information and the like are described as stored in the HD 19.

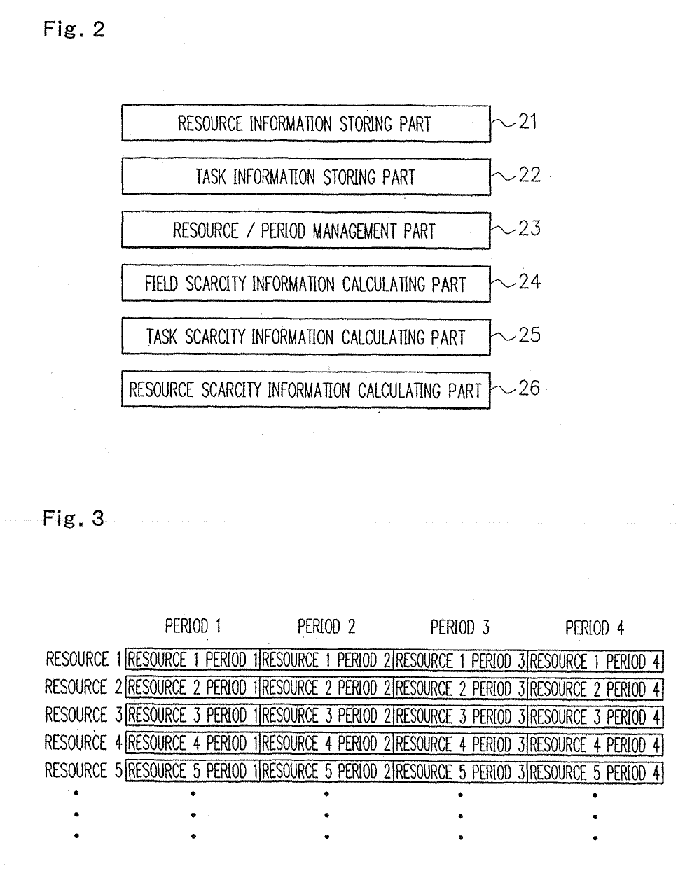

An example of a functional configuration of the information processing unit 1 consisting of the CPU 17, the RAM 16, the HD 19 and an analysis data display program and the like is shown in FIG. 2. FIG. 2 is a functional block diagram (1) of an example of an information processing unit. As shown in FIG. 2, the information processing unit 1 includes a resource information storing part 21, a task information storing part 22, a resource/period management part 23, a field scarcity information calculating part 24, a task scarcity information calculating part 25 and a resource scarcity information calculating part 26 as functional components.

The resource information storing part 21 stores resource information. As resource information, resource identifying information for identifying a resource, a name of a resource (in the embodiment, an examiner having one or more examination qualifications relating to the ISO as mentioned above), field information relating to examination qualifications of the ISO owned by a resource and the like are included. If a resource has a plurality of examination qualifications of the ISO, a plurality of pieces of field information are included in a piece of resource information.

The task information storing part 22 stores task information. As task information, task identifying information for identifying a task, information on a field relating to a task (in the embodiment, an examined matter as mentioned above), information on a place of a task, information on a task length, information on the number of resources needed by a task, and task state information indicating a state of a task and the like. If a task needs a plurality of fields (fields relating to examination qualifications of the ISO), a plurality of pieces of field information are included in a piece of task information.

The resource/period management part 23 manages the resource identifying information and the period (for example, a week or five days in a week except for Saturday and Sunday in a week) consisting of a plurality of period units (for example, a day) associated with one other by using a table (resource/period management table). Here, FIG. 3 is a conceptual diagram where a resource/period management part 23 manages resource identifying information and a period associated with each other by using a table. In FIG. 3, an example where a month is divided into four periods and managed is shown. As mentioned above, each period includes a week or five days except for Saturday and Sunday in a week for example. For simplicity of descriptions below, description is made by taking an example that each period includes five days. That, however, does not limit the present invention.

The resource/period management part 23 executes allocation of a set of resource identifying information and a period as shown in FIG. 3 and a task to be processed (task information) based on constraint conditions. To describe it more specifically, the resource/period management part 23 obtains and manages a representative frame indicating all or some of period units which actually can be allocated to tasks within the periods for each set of the resource identifying information and period, and executes allocation of representative frames and a task to be processed based on constraint conditions by using a constraint propagation technique, for example.

As constraint conditions, “Does specialty of an examiner (for example, field information relating to examination qualifications of the ISO owned by a resource) fulfill specialty required for an examined matter (for example, field information relating to a task)”, “the upper limit of moving between corporations to be examined is within four hours, for example”, “the upper limit of an examined matter for an examiner to examine in a period is within three matters, for example”, “do not allocate an examined matter which requires personnel to stay the night over the day before at the next day of absence with leave”, or the like can be considered. The constraint conditions are stored in the HD 19 or the like, for example, as constraint conditions information; and the resource/period management part 23 performs an allocation process by obtaining (or referencing) the constraint conditions information so as to fulfill the constraint conditions.

As mentioned above, the resource/period management part 23 can reduce a solution space associated with scheduling as much as possible by executing allocation of a set of a period including a plurality of period units (for example, five days except for Saturday and Sunday in a week) and resources and a task, instead of executing an allocation process of a task and a resource in a period unit (for example, a day).

As mentioned above, the resource/period management part 23 can prevent unwanted back track and accordingly reduce a time for obtaining a solution by executing allocation of a set of a period including a plurality of period units (for example, five days except for Saturday and Sunday in a week) and resources and a task, and also executing an allocation process of periods prior to resources to a task in a set of a period and a resource allocated to a task, instead of deciding a starting period unit of a task (for example, the starting day of a task) after deciding a resource which can be allocated to a task.

For example, the resource/period management part 23 selects a resource that the length of a representative frame of a period allocated to the task is not shorter than the length of the task being examined in case of selecting the first resource after allocating a period to the task, and decides the starting period unit and the ending period unit of a task being examined by filling the tasks being examined from the back in the representative frame. When the resource/period management part 23 selects the second resource and later, it selects a resource that the representative frame of a period allocated to a task includes the decided starting period unit to the ending period unit of a task being examined, so that the length of period of representative frames overlap between a plurality of resources can be never shorter than the length of the task.

If no resource whose representative frame of a period allocated to the task includes the decided starting period unit to the ending period unit of a task being examined is found, a backtrack occurs and the resource/period management part 23 tries selection of a resource again. In the embodiment, however, as it is assumed that options of resource are more than the options of period, possibility of back track to occur is low.

As mentioned above, the resource/period management part 23 can dynamically reduce a solution space and accordingly reduce a time to obtain a solution by executing allocation by using a constraint propagation technique, for example.

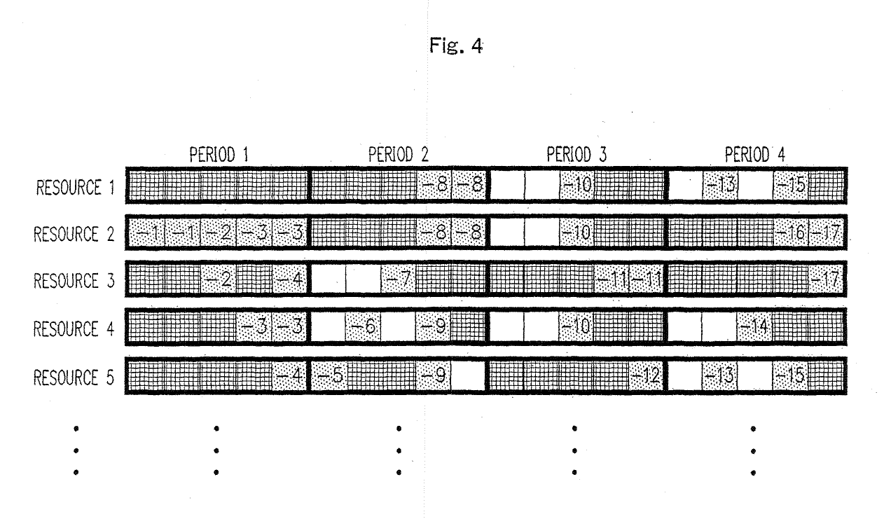

FIG. 4 is a diagram (1) showing a representative frame. The shadowed part of each set shown in FIG. 4 is a representative frame. In FIG. 4, dotted parts with negative numbers given therein are allocated frames which are manually allocated by a user (that is to say, the resource/period management part 23 based on user's input manipulation). In FIG. 4, a minus represents that it is allocated manually and the number represents task identifying information for identifying a task. In FIG. 4, blank parts are frames which are not allocated frames and which are not representative frames (an unallocated non-representative frame).

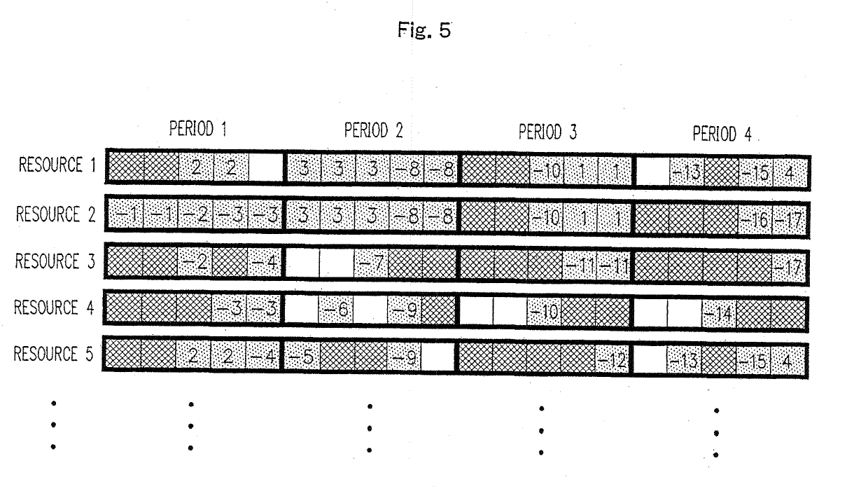

The resource/period management part 23 obtains and manages a representative frame as shown in FIG. 4 and executes (automatic) allocation of a representative frame and a task to be processed based on constraint conditions. FIG. 5 is a diagram (2) showing a representative frame. A dotted part with a number without a minus sign shown in FIG. 5 is an allocated frame which is automatically allocated to a task by the resource/period management part 23. That is to say, the dotted part with a number without a minus sign shown in FIG. 5 is a part which was a representative frame (all or part) in FIG. 4, and a part which becomes an allocated frame as a result of automatic allocation of a representative frame and a task to be processed by the resource/period management part 23. If the resource/period management part 23 allocates a task to be processed to a part of the representative frame, for example, it makes all or part of the remaining frame as representative frames and updates the representative frame. The resource/period management part 23 updates the representative frame (or a set of a period and a resource) each time when it executes allocation of the representative frame (or a set of a period and a resource) and a task to be processed once.

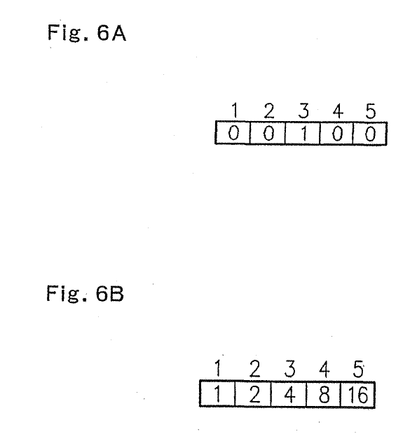

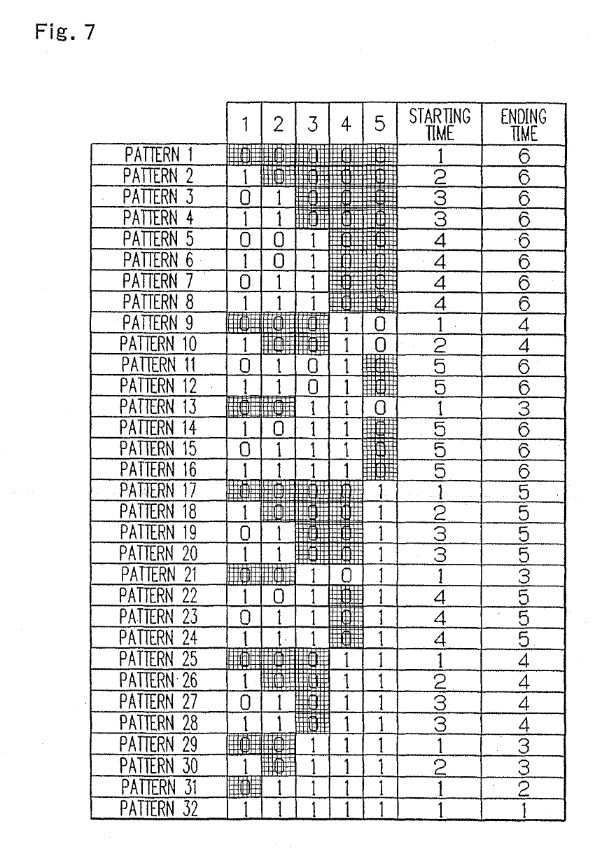

Here, the way to manage a representative frame by the resource/period management part 23 will be descried by using FIG. 6 and FIG. 7. FIG. 6A is a diagram showing an example of a pattern indicating an allocating state within a period. For example, the resource/period management part 23 keeps and manages a pattern indicating an allocating state within a period shown in FIG. 6A on a memory (for example, RAM 16 or the like) in association with each set shown in FIG. 4 or FIG. 5. The number 0 “zero” in each of the frames of FIG. 6A represents that it is not an allocated frame (i.e., it is a representative frame or an unallocated non-representative frame), and the number 1 in each of the frames represents that it is an allocated frame. That is to say, FIG. 6A represents an allocating state of a resource 4 period 3 of FIG. 4 (and FIG. 5) or a resource 4 period 4, for example.

The resource/period management part 23 keeps values which the part 23 calculates by subtracting one from respective numbers corresponding to period units consisting of a period (in the example of FIG. 6B, 1, 2, 3, 4, 5) (in the example of FIG. 6B, 1−1=0, 2−1=1, 3−1=2, 4−1=3, 5−1=4) as values of power exponent of two (i.e., 2⁰=1, 2¹=2, 2²=4, 2³=8, 2⁴=16) in order to obtain pattern numbers as shown in FIG. 7 to be described later from a pattern representing allocating states shown in FIG. 6A on a memory, for example. The resource/period management part 23 calculates the value of an inner product of a value shown in FIG. 6B and (a value representing) a pattern representing an allocate state as shown in FIG. 6A added with one as a pattern number, and based on the calculated pattern number, references pattern information (pattern information table) kept and managed on the memory (for example, the RAM 16 or the like) to grasp (or manage) a representative frame of each set of resource identifying information and a period or grasp (or manage) the starting period unit of the representative frame and the ending period unit of the representative frame.

For example, in the case shown in FIG. 6A and FIG. 6B, when the resource/period management part 23 takes the inner product, the value is 4, thus, it references FIG. 7 by using a value 1 added to 4, i.e., 5 as a pattern number. FIG. 7 is a diagram showing an example of pattern number information (pattern number information table). The resource/period management part 23 can recognize that the representative frames of a resource 4 period 3 and a resource 4 period 4 of FIG. 4 (and FIG. 5) is a period unit 4 and a period unit 5 (shadowed parts in FIG. 7) by referencing pattern number information as shown in FIG. 7 based on a pattern number. The resource/period management part 23 can recognize the starting period unit of the representative frame of a resource 1 period 1 of FIG. 4 is a period unit 1 (for example, Monday) and the ending period unit is 5 which is 1 subtracted from a period unit 6 (for example, Friday) by referencing the pattern number information as shown in FIG. 7 based on pattern numbers. In the example of FIG. 7, the value that 1 is added to the actual ending period unit is considered as the ending period unit so that the resource/period management part 23 or the like can calculate the length of the representative frame by subtracting the starting period unit from the ending period unit.

When the resource/period management part 23 allocates a task to a representative frame and changes the representative frame as described by using FIG. 5, it manages a pattern representing an allocate state as shown in FIG. 6A in association with each set. Therefore, the part 23 can manage changing (or updating) of the representative frame by calculating pattern numbers from the above-mentioned calculation, and based on the calculated pattern number, referencing the pattern number information as shown in FIG. 7.

In the embodiment of the present invention, if the representative frames are “filled from the back”, i.e., for example as shown in the pattern 5 of FIG. 7, if a period unit 1 and a period unit 2, and a period unit 4 and a period unit 5 are empty (not allocated), the back period units 4 and 5 are considered as the representative frames, though, that does not limit implementation of the present invention and representative frames may be “filled from the top”.

Returning to the description of FIG. 2, the field scarcity information calculating part 24 calculates field scarcity information. To describe it more specifically, the field scarcity information calculating part 24 calculates a capacity (capacity information) relating to a field (field information) as the sum of empty times of the resources (period unit) for resources relating to the field.

As mentioned above, as the resource information storing part 21 stores field information and the like relating to examination qualifications of the ISO owned by resources, the field scarcity information calculating part 24 searches resource information storing part 21 by using field information to be processed, obtains resource identifying information of the resources having the field information as a searched result, passes the obtained resource identifying information to the resource/period management part 23, receives empty times of a resource corresponding to the passed resource identifying information from the resource/period management part 23 and the like, sums the received empty times of the resources, and calculates a capacity relating to the field.

The field scarcity information calculating part 24 calculates a demand (demand information) relating to a field (field information) as the sum of lengths of the tasks for tasks relating to the field.

As the task information storing part 22 stores field information relating to tasks or length information of tasks as mentioned above, the field scarcity information calculating part 24 searches the task information storing part 22 by using field information to be processed and obtains length information of tasks having the field information as a searched result, sums the obtained length information of tasks and calculates a demand relating to the field.

The field scarcity information calculating part 24 calculates field scarcity information based on an expression shown below by using a capacity and a demand relating to the calculated field.

Field scarcity information=demand relating to a field/capacity relating to a field

For example, the field scarcity information calculating part 24 keeps and manages the calculated field scarcity information and field information relating to the field in the RAM 16 and the like in association with each other. Here, although it is assumed that the field scarcity information calculating part 24 manages the calculated field scarcity information and the like, field scarcity information managing part and the like may manage field scarcity information and the like. For simplicity of description below, it is assumed that the field scarcity information calculating part 24 keeps and manages the calculated field scarcity information and the field information relating to the field in association with each other as mentioned above.

The field scarcity information calculating part 24 calculates its keeping and managing field scarcity information again and updates the field scarcity information each time the resource/period management part 23 executes allocation once of a set of resource identifying information and a period and a task to be processed (task information), for example.

If one or more tasks needs a plurality of resources, for example, if the resource/period management part 23 executes allocation of a set of resource identifying information and a period and a task to be processed (task information) for a plurality of times and a plurality of resources needed by the tasks are decided, the field scarcity information calculating part 24 may calculate its keeping and managing field scarcity information again and updates the field scarcity information; or if the resource/period management part 23 executes allocation of a set of resource identifying information and a period and a task to be processed (task information) once and a resource is decided among a plurality of resources needed by the task, it may calculate its keeping and managing field scarcity information again and update field scarcity information. For simplicity of description below, it is assumed that the field scarcity information calculating part 24 calculates its keeping and managing field scarcity information again and updates field scarcity information each time the resource/period management part 23 executes allocation of a set of resource identifying information and a period and a task to be processed (task information) once.

As such, the field scarcity information calculating part 24 can calculate and update task scarcity information or resource scarcity information to be described later by using correct field scarcity information by updating field scarcity information.

The task scarcity information calculating part 25 calculates task scarcity information. To describe it more specifically, the task scarcity information calculating part 25 calculates task scarcity information as a product of field scarcity information relating to a task (if a plurality of pieces of field scarcity information relating to a task are present, field scarcity information relating to a task summed) and information on the length of a task.

As mentioned above, the task information storing part 22 stores task identifying information, field information relating to a task, information on the length of a task and the like, the task scarcity information calculating part 25 searches the task information storing part 22 by using task identifying information for identifying a task to be processed, and obtains the field information relating to a task identified by the task identifying information or the information on the length of a task as a searched result.

The task scarcity information calculating part 25 keeps and manages the calculated task scarcity information in the RAM 16 or the like in association with task identifying information, for example. Here, although it is assumed that the task scarcity information calculating part 25 manages the calculated task scarcity information, the task scarcity information managing part or the like may manage task scarcity information or the like. For simplicity of description below, it is assumed that the task scarcity information calculating part 25 keeps and manages the calculated task scarcity information and task identifying information, for example, in associated with each other as mentioned above.

As such, the task scarcity information calculating part 25 can correctly evaluate scarcity of a task by calculating task scarcity information by using field scarcity information.

The task scarcity information calculating part 25 calculates its keeping and managing task scarcity information again and updates task scarcity information each time the resource/period management part 23 executes allocation of a set of resource identifying information and a period and a task to be processed (task information) once.

The task scarcity information calculating part 25 may calculate its keeping and managing task scarcity information again and update task scarcity information, if the resource/period management part 23 executes allocation of a set of resource identifying information and a period and a task to be processed (task information) for a plurality of times and a plurality of resources needed by a task is decided such as if one or more tasks needs a plurality of resources and the like, for example; or the part 25 may calculate its keeping and managing task scarcity information again and update task scarcity information, if the resource/period management part 23 executes allocation of a set of resource identifying information and a period and a task to be processed (task information) once and a resource is decided among a plurality of resources needed by a task. For simplicity of description below, it is assumed that the task scarcity information calculating part 25 calculates its keeping and managing task scarcity information again and updates task scarcity information each time the resource/period management part 23 executes allocation of a set of resource identifying information and a period and a task to be processed (task information) once.

As such, the resource/period management part 23 and the like can execute an automatic allocation process as described later by using correct task scarcity information, for example, as the task scarcity information calculating part 25 updates task scarcity information.

The resource scarcity information calculating part 26 calculates resource scarcity information. To describe it more specifically, the resource scarcity information calculating part 26 calculates resource scarcity information as field scarcity information relating to a resource (if a plurality of pieces of field scarcity information relating to a resource are present, a sum of field scarcity information relating to a resource).

As mentioned above, as the resource information storing part 21 stores resource identifying information and field information and the like relating to examination qualifications of the ISO owned by a resource, the resource scarcity information calculating part 26 searches resource information storing part 21 by using resource identifying information for identifying resources to be processed, and obtains field information relating to a resource identified by the resource identifying information as a searched result.

As mentioned above, as the field scarcity information calculating part 24 keeps and manages the calculated field scarcity information and the field information relating to field in association with each other, the resource scarcity information calculating part 26 passes the obtained field information relating to the resources to the field scarcity information calculating part 24 and receives field scarcity information relating to a resource corresponding to field information relating to the passed resource from the field scarcity information calculating part 24, and calculates the received field scarcity information relating to resources (if a plurality of field scarcity information relating to a resource are present, a sum of field scarcity information relating to a resource) as resource scarcity information.

The resource scarcity information calculating part 26 keeps and manages the calculated resource scarcity information in the RAM 16 and the like in association with resource identifying information, for example. Here, although it is assumed that the resource scarcity information calculating part 26 manages the calculated resource scarcity information and the like, resource scarcity information management part or the like may manage the resource scarcity information and the like. For the simplicity of description below, the resource scarcity information calculating part 26 keeps and manages the calculated resource scarcity information and, for example, the resource identifying information in association with each other as mentioned above.

As such, the resource scarcity information calculating part 26 can correctly evaluate scarcity of a resource by calculating resource scarcity information by using field scarcity information.

The resource scarcity information calculating part 26 calculates its keeping and managing resource scarcity information again and updates resource scarcity information each time the resource/period management part 23 executes allocation of a set of resource identifying information and a period and a task to be processed (task information) once, and updates resource scarcity information.

The resource scarcity information calculating part 26 may calculate its keeping and managing resource scarcity information again and update resource scarcity information if the resource/period management part 23 executes allocation of a set of resource identifying information and a period and a task to be processed (task information) for a plurality of times and a plurality of resources needed by the tasks are decided, such as if one or more tasks need a plurality of resources and the like; or the part 26 may calculate its keeping and managing resource scarcity information again and update resource scarcity information if the resource/period management part 23 executes allocation of a set of resource identifying information and a period and a task to be processed (task information) once and a resource is decided among a plurality of resources needed by the task. For simplicity of description below, it is assumed that the resource scarcity information calculating part 26 calculates its keeping and managing resource scarcity information again and updates resource scarcity information if the resource/period management part 23 executes allocation of a set of resource identifying information and a period and a task to be processed (task information) once.

As such, the resource/period management part 23 or the like can execute an automatic allocation process by using correct resource scarcity information to be described later, for example, as the resource scarcity information calculating part 26 updates resource scarcity information, for example.

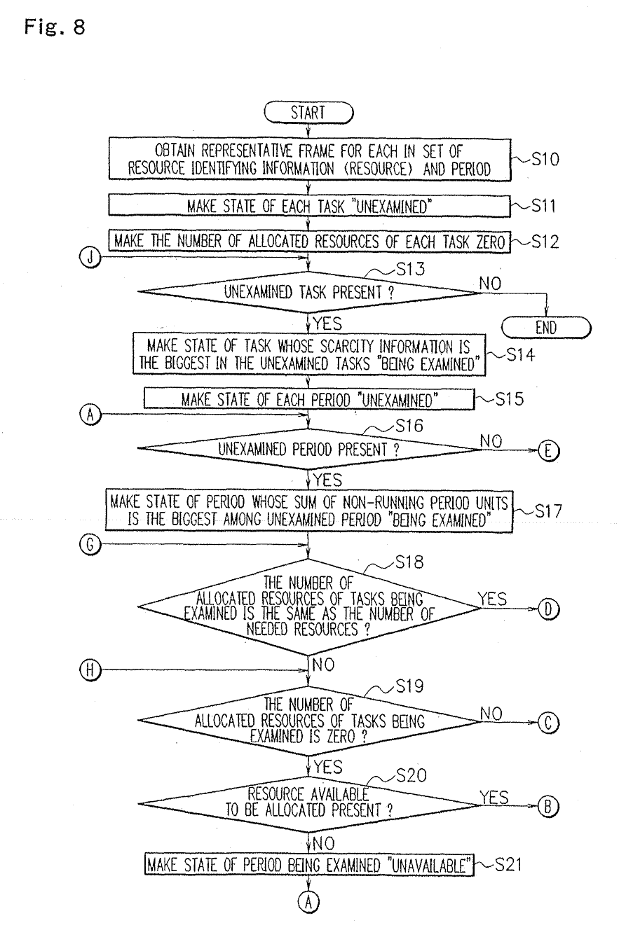

An example of an automatic allocation process is shown in FIG. 8 to FIG. 11 below. FIG. 8 is a flowchart (1) showing an automatic allocation process.

At the step S10, the resource/period management part 23 obtains a representative frame for each in a set of resource identifying information (hereinafter, for simplicity of description, the resource identifying information or resource information and a resource are merely called a resource without distinguished from one another, if otherwise mentioned) and a period.

The process proceeds to the step S11 following to the step S10, the resource/period management part 23 makes a state of each task “unexamined”. To describe it more specifically, the resource/period management part 23 sets a value representing “unexamined” (for example, 0 or the like) to task state information included in the task information stored in the task information storing part 22.

The process proceeds to the step S12 following to the step S11, the resource/period management part 23 makes the number of allocated resources (examiners) of each task (examined matter) zero. To describing it more specifically, the resource/period management part 23 sets zero (0) to a variable or the like representing the number of allocated resources of a task kept on the RAM 16, for example.

At the step S13, the resource/period management part 23 determines whether an unexamined task is present or not by referencing task state information included in task information of tasks identified by the task identifying information stored in the task information storing part 22 based on task identifying information for identifying a task, for example. If the resource/period management part 23 determines that an unexamined task is present (YES at the step S13), the process proceeds to the step S14, and if it determines that an unexamined task is not present (NO at the step S13), an automatic allocation process ends.

At the step S14, the resource/period management part 23 makes a state of a task whose scarcity information is the biggest in the unexamined tasks “being examined”. To describe it more specifically, the resource/period management part 23 passes task identifying information for identifying an unexamined task, for example, to the task scarcity information calculating part 25, and receives the task identifying information for identifying a task whose scarcity information is the biggest from the task scarcity information calculating part 25 or the like.

The resource/period management part 23 sets a value (for example, 1 or the like) representing “being examined” to the task state information included in the task information of the task identified by the task identifying information stored in the task information storing part 22 based on the task identifying information for identifying the task received from the task scarcity information calculating part 25 whose scarcity information is the biggest.

As shown in the step S14, the resource/period management part 23 can delay depletion of a resource and accordingly reduce tasks to which no resource is allocated by executing an allocation process from the task whose scarcity information is the biggest.

The process proceeds to the step S15 following to the step S14, the resource/period management part 23 makes a state of each period “unexamined”. To describe it more specifically, the resource/period management part 23 sets a value representing that it is “unexamined” (for example, 0 or the like) to respective variables indicating states of periods kept on the RAM 16, for example.

At the step S16, the resource/period management part 23 determines whether an unexamined period is present or not. To describe it more specifically, the resource/period management part 23 determines whether a value representing that it is “unexamined” (for example, 0 or the like) is set to each variable or not by referencing respective variables indicating states of periods kept on the RAM 16, for example.

If the resource/period management part 23 determines that an unexamined period is present (YES at the step S16), the process proceeds to the step S17, and if it determines that no unexamined period is present (No at the step S16), the process proceeds to the step S60 shown in FIG. 12 to be described later.

At the step S17, the resource/period management part 23 makes a state of a period whose sum of non-running period units is the biggest (i.e., an unallocated representative frame and an unallocated non-representative frame) among an unexamined period “being examined”. To describe it more specifically, the resource/period management part 23 sets a value indicating that it is “being examined” (for example, 1 or the like) to a variable indicating a state of a period whose sum of non-running period units is the biggest among an unexamined period. Here, the term “unallocated representative frame” is a representative frame which has not been allocated”.

At the step S18, the resource/period management part 23 determines whether the number of allocated resources of tasks being examined is the same as the number of needed resources or not. To describe it more specifically, the resource/period management part 23 determines whether the number of allocated resources of the tasks being examined is the same as the number of needed resources by comparing a value set to a variable representing the number of allocated resources of the tasks kept on the RAM 16 and information on the number of resources needed by the tasks obtained as it references the task information storing part 22 based on task identifying information for identifying an examined task.

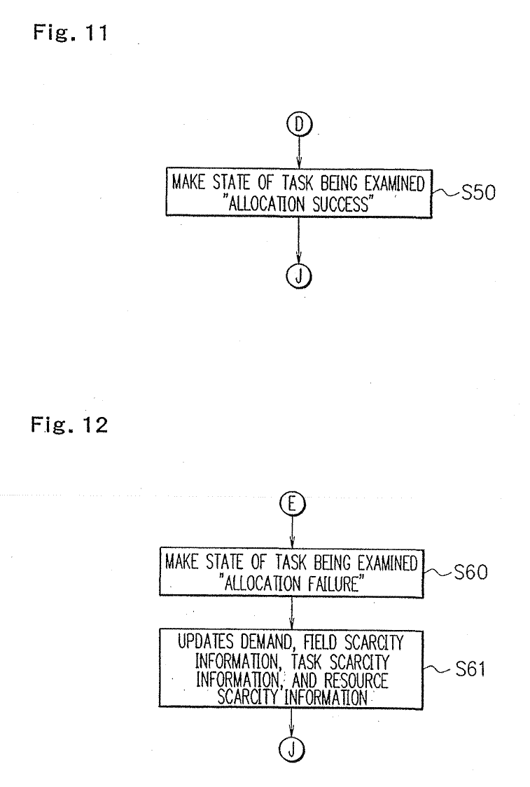

If the resource/period management part 23 determines that the number of allocated resources of tasks being examined is the same as the number of resources needed (YES at the step S18), the process proceeds to the step S50 shown in FIG. 11 to be described later, and if the part 23 determines that the number of allocated resources of tasks being examined is not the same as the number of resources needed (NO at the step S18), the process proceeds to the step S19.

At the step S19, the resource/period management part 23 determines whether the number of allocated resources of tasks being examined is zero or not. To describe it more specifically, the resource/period management part 23 determines whether a value set to a variable representing the number of resources allocated to a task kept on the RAM 16 is zero or not by referencing the value.

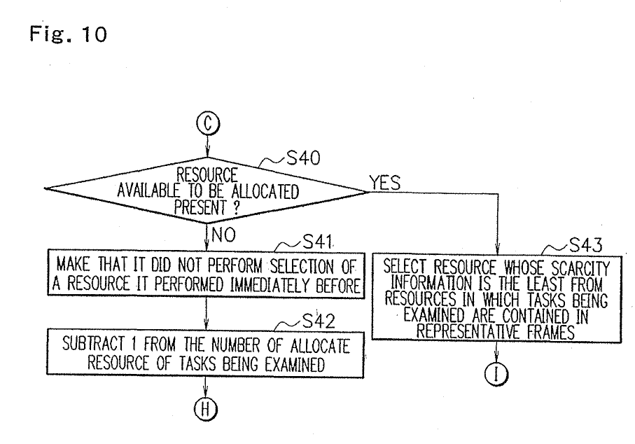

If the resource/period management part 23 determines that the number of allocated resources of tasks being examined is zero (YES at the step S19), the process proceeds to the step S20, and if the part 23 determines that the number of allocated resources of tasks being examined is not zero (NO at the step S19), the process proceeds to the step S40 shown in FIG. 10 to be described later.

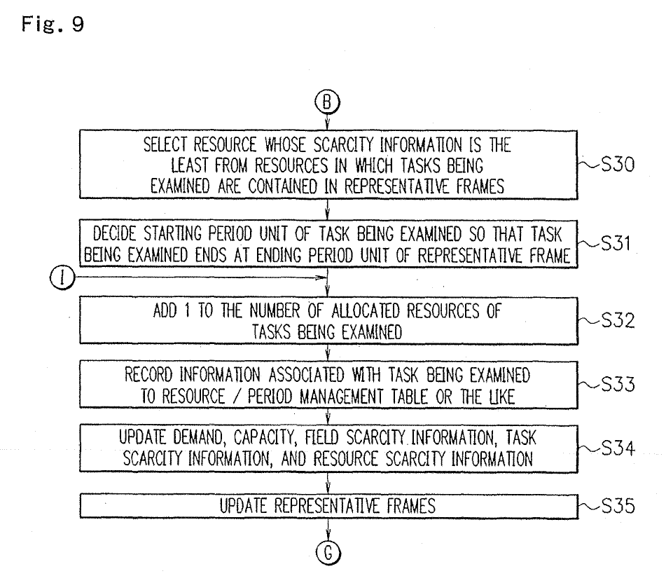

At the step S20, the resource/period management part 23 determines whether a resource available to be allocated to tasks being examined is present or not. If the resource/period management part 23 determines that a resource available to be allocated to tasks being examined is present (YES at the step 20), the process proceeds to the step S30 shown in FIG. 9 to be described later, and if it determines that a resource available to be allocated to tasks being examined is not present (NO at the step S20), the process proceeds to the step S21.

At the step S21, the resource/period management part 23 makes a state of a period being examined “unavailable” and the process proceeds to the step S16. To describe it more specifically, the resource/period management part 23 sets a value representing that it is “unavailable” (for example, 2 or the like) to a variable indicating a state of a period being examined kept on the RAM 16, for example, and the process proceeds to the step S16.

FIG. 9 is a flowchart (2) showing an automatic allocation process. At the step S30, the resource/period management part 23 selects a resource whose scarcity information is the least from resources in which tasks being examined are contained in representative frames. To describe it more specifically, the resource/period management part 23 passes resource identifying information for identifying a resource in which tasks being examined are contained in representative frames to the resource scarcity information calculating part 26, and receives resource identifying information for identifying resource whose scarcity information is the least from the resource scarcity information calculating part 26 or the like.

The resource/period management part 23 selects the resource based on resource identifying information for identifying a resource received from the resource scarcity information calculating part 26 or the like whose scarcity information is the least.

As shown in the step S30, the resource/period management part 23 can delay depletion of a resource and accordingly reduce a task to which no resource is allocated by executing an allocation process from the resource whose scarcity information is the least.

The process proceeds to the step S31 following to the step S30, the resource/period management part 23 decides the starting period unit (for example, the starting day) of a task being examined so that a task being examined ends at the ending period unit (for example, the last day) of the representative frame.

At the step S32, the resource/period management part 23 adds 1 to the number of allocated resources of tasks being examined. To describe it more specifically, the resource/period management part 23 adds 1 to a value of the variable or the like representing the number of allocated resources of tasks being examined kept on the RAM 16, for example.

The process proceeds to the step S33 following to the step S32, the resource/period management part 23 records identifying information and the like for identifying a task being examined to a resource/period management table or the like.

The process proceeds to the step S34 following to the step S33, the field scarcity information calculating part 24 calculates a demand relating to a field and capacity relating to a field again and updates the field scarcity information. The task scarcity information calculating part 25 calculates task scarcity information again and updates task scarcity information. The resource scarcity information calculating part 26 calculates resource scarcity information again and updates resource scarcity information.

The process proceeds to the step S35 following to the step S34, and the resource/period management part 23 updates the representative frames and the process proceeds to the step S18 shown in FIG. 8.

FIG. 10 is a flowchart (3) showing an automatic allocation process. At the step S40, the resource/period management part 23 determines whether a resource available to be allocated is present or not. If the resource/period management part 23 determines that a resource available to be allocated is present (YES at the step S40), the process proceeds to the step S43, and if it determines that a resource available to be allocated is not present (NO at the step S40), the process proceeds to the step S41.

At the step S41, the resource/period management part 23 makes that it did not perform selection of a resource it performed immediately before. To describe it more specifically, the resource/period management part 23 deletes the record performed at the step S33 and the like, for example.

The process proceeds to the step S42 following to the step S41, the resource/period management part 23 subtracts 1 from the number of allocated resource of tasks being examined and the process proceeds to the step S19 shown in FIG. 8. To describe it more specifically, the resource/period management part 23 subtracts 1 from the value of a variable and the like representing the number of allocated resources of tasks being examined kept on the RAM 16, for example, and the process proceeds to the step S19 shown in FIG. 8.

On the other hand, at the step S43, the resource/period management part 23 selects a resource whose scarcity information is the least from the resources in which tasks being examined are contained in the representative frames, and the process proceeds to the step S32 shown in FIG. 9. To describe it more specifically, the resource/period management part 23 passes resource identifying information for identifying a resource in which a task being examined is contained in a representative frame to the resource scarcity information calculating part 26 and receives the resource identifying information for identifying a resource whose scarcity information is the least from the resource scarcity information calculating part 26.

The resource/period management part 23 selects a resource based on resource identifying information for identifying a resource received from the resource scarcity information calculating part 26 whose scarcity information is the least and the process proceeds to the step S32 shown in FIG. 9.

As shown in the step S43, the resource/period management part 23 can delay depletion of resources and accordingly reduce tasks to which resources are not allocated by executing an allocation process from the resource whose scarcity information is the least.

FIG. 11 is a flowchart (4) showing an automatic allocation process. At the step S50, the resource/period management part 23 makes a state of a task being examined “allocation success” and the process proceeds to the step S13 shown in FIG. 8. To describe it more specifically, the resource/period management part 23 sets a value representing “allocation success” (for example, 2 or the like) to task state information included in task information of a task identified by the task identifying information stored in the task information storing part 22 based on task identifying information for identifying a task being examined and the process proceeds to the step S13 shown in FIG. 8.

FIG. 12 is a flowchart (5) showing an automatic allocation process. At the step S60, the resource/period management part 23 makes a state of a task being examined “allocation failure”. To describe it more specifically, the resource/period management part 23 sets a value representing “allocation failure” (for example, 3 or the like) to task state information included in task information of a task identified by the task identifying information stored in the task information storing part 22 based on task identifying information for identifying a task being examined.

The process proceeds to the step S61 following to the step S60 and the field scarcity information calculating part 24 calculates a demand relating to a field again and updates field scarcity information. The task scarcity information calculating part 25 calculates task scarcity information again and updates task scarcity information. The resource scarcity information calculating part 26 calculates resource scarcity information again and updates resource scarcity information. When a process at the step S61 ends, the process proceeds to the step S13 shown in FIG. 8.

As mentioned above, according to the embodiment, a solution space relating to scheduling can be reduced as much as possible. According to the embodiment, as a solution space relating to scheduling is reduced, a time of a solution searching process can be reduced.

As a preferred embodiment of the present invention has been described above, the present invention is not limited to a specific embodiment and various modifications and changes are available within a spirit of the present invention described in the claims.

For example, if the resource/period management part 23 executes allocation when it executes allocation between a set of resource identifying information and a period and a task to be processed, it may calculate transportation expenses, lodging expenses and the like which a resource needs to execute a task and execute allocation so that the transportation expenses and lodging expenses are as least as possible or so that the transportation expenses and lodging expenses fulfill constraint conditions or the like relating to the transportation expenses and lodging expenses.

### Second Embodiment

In the embodiment, an example where the resource/period management part 23 executes allocation so that transportation expenses, lodging expenses and the like required by a resource to perform a task are as least as possible, or so that transportation expenses and lodging expenses fulfill constraint conditions or the like relating to the transportation expenses and the lodging expenses is shown. The embodiment is described by assuming that a cost information calculating part 29 to be described later calculates a cost (i.e., transportation expenses, lodging expenses and the like) required for a resource to perform a task instead of the resource/period management part 23 calculates transportation expenses, lodging expenses and the like required for a resource to perform a task.

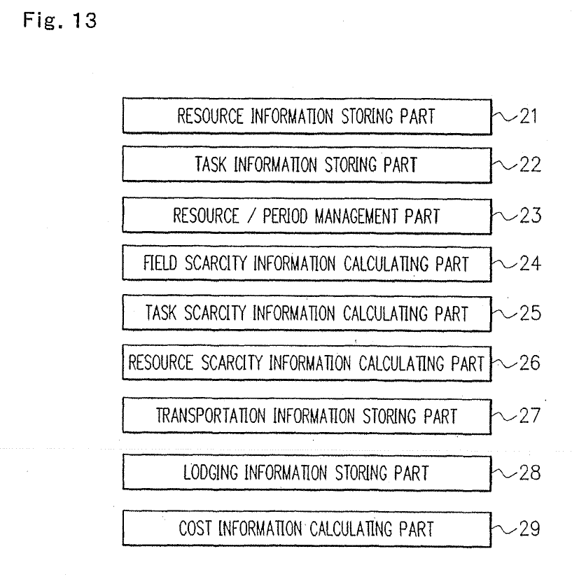

FIG. 13 is a functional diagram (2) of an example of an information processing unit. As shown in FIG. 13, the information processing unit 1 includes the resource information storing part 21, the task information storing part 22, the resource/period management part 23, the field scarcity information calculating part 24, the task scarcity information calculating part 25, the resource scarcity information calculating part 26, a transportation information storing part 27, a loading information storing part 28 and a cost information calculating part 29 as functional components.

Each function of the resource information storing part 21, the task information storing part 22, the resource/period management part 23, the field scarcity information calculating part 24, the task scarcity information calculating part 25 and the resource scarcity information calculating part 26 is the same as that of the abovementioned first embodiment.

The resource information storing part 21 of the embodiment, however, further stores resource home information (for example, a street address, the nearest station and the like) in addition to the abovementioned information as resource information.

The transportation information storing part 27 stores route information relating to means of transportation (for example, bus, train, plane, ship and the like) or transportation expenses information as transportation information. The lodging information storing part 28 stores place information (street address information) relating to a lodging (for example, a hotel or the like) or lodging expenses information, nearest station information and the like as lodging information.

The transportation information stored in the transportation information storing part 27 or the lodging information stored in the lodging information storing part 28 are assumed to be stored in the HD 19 or the like.

The cost information calculating part 29 calculates an increase of cost information where a resource is allocated to a task based on the information on a home of a resource stored in the resource information storing part 21, information on a place of a task stored in the task information storing part 22, transportation information stored in the transportation information storing part 27, lodging information stored in the lodging information storing part 28 and the like. Here, the term “cost information” is a value of the sum of transportation expenses and/or lodging expenses and the like required when a resource performs a task.

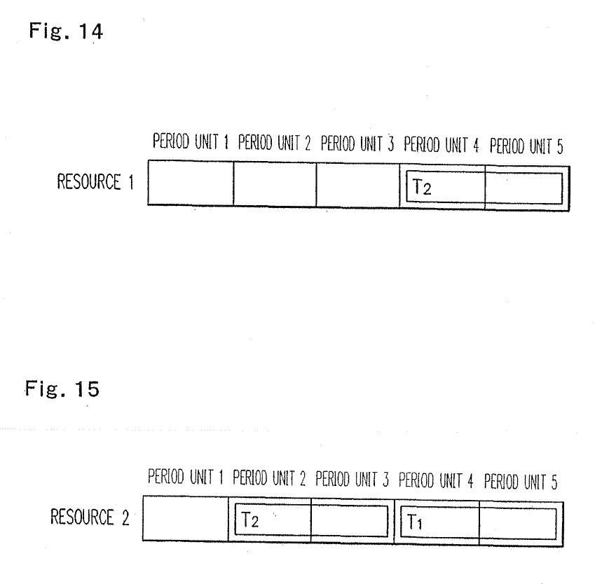

An example of a method for calculating an increase of cost information in the cost information calculating part 29 will be described further in detail by using FIG. 14 to FIG. 17.

FIG. 14 is a conceptual diagram of a case where a task 2 is allocated to a resource 1. In FIG. 14, the resource 1 considers that a task is not allocated to a period unit 1 to a period unit 5 until the task 2 is allocated.

In such a case, the cost information calculating part 29 determines, for example, that the resource 1 leaves the resource 1's home to a place where the task 2 is performed and returns to the home every day based on information on the resource 1's home and information on the place of the task 2.

Then, the cost information calculating part 29 calculates an increase of cost information when the task 2 is allocated to the resource 1 as

(R1→T2)+(T2→R1)+(R1→T2)+(T2→R1).

Here, R1→T2 represents transportation expenses from the home of the resource 1 to the place where the task 2 is performed. T2→R1 represents transportation expenses from the place where the task 2 is performed to the home of the resource 1.

FIG. 15 is a conceptual diagram of a case where the task 2 is allocated to a resource 2. In FIG. 15, the resource 2 considers the task 1 has been allocated to a period unit 4 and a period unit 5. The resource 2 is assumed to leave the home to the place where the task 1 is performed and returns to the home every day.

In such a case, the cost information calculating part 29 determines, for example, that the resource 2 leaves the home to the place where the task 2 is performed and returns to the home every day based on information on the home of the resource 2 and information on the place of the task 2.

Then, the cost information calculating part 29 calculates an increase of cost information when the task 2 is allocated to the resource 2 as

{A}−{B′}.

### Here, A′ is

(R2→>T2)+(T2→R2)+(R2→T2)+(T2→R2)+(R2→T1)+(T1→R2)+(R2→T1)+(T1→R2).

### B′ is

(R2→T1)+(T1→R2)+(R2→T1)+(T1→R2)

B′ is cost information before the task 2 is allocated to the resource 2.

As a result, {A′}−{B′} is

{(R2→T2)+(T2→R2)}>×2.

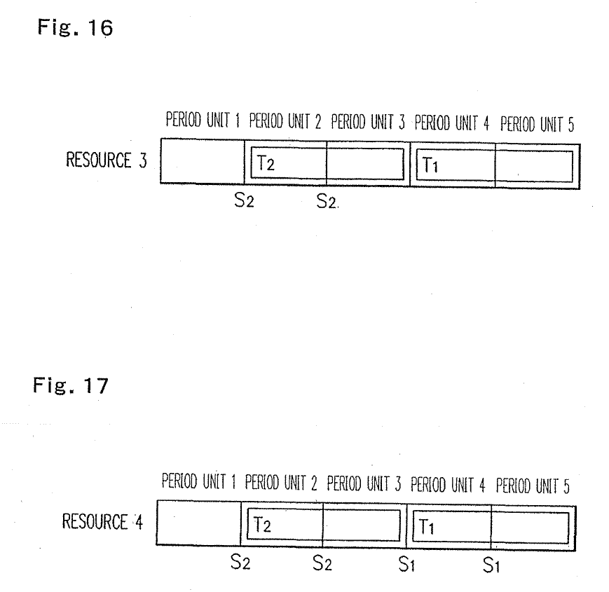

FIG. 16 is a conceptual diagram of a case where the task 2 is allocated to a resource 3. In FIG. 16, the resource 3 considers that the task 1 has been allocated to a period unit 4 and a period unit 5. The resource 3 is assumed to leave the home to a place where the task 1 is performed and returns to the home every day.

In such a case, the cost information calculating part 29, for example, determines that the resource 3 leaves to a lodging to a place where the task 2 is performed and returns to the lodging at the first day, and when the task 2 ends, returns to the home once, based on information on the home of the resource 3, information on the place of the task 2 or information on the place of the task 1. The nearest station to the lodging and the nearest station to the place where the task 2 is performed are the same station so that transportation expenses are not required to move from the lodging place to the place where the task 2 is performed. That is also true below, as the nearest station to the lodging and the nearest station to the place where the task is performed are assumed to be the same station.

Then, the cost information calculating part 29 calculates an increase of cost information when the task 2 is allocated to the resource 3 as

{C′}−{D′}.

### Here, C′ is

(R3→T2)+(T2→R3)+(R3→T1)+(T1→R3)+(R3→T1)+(T1→R3)+S2×2.

Here, S2 is lodging expenses for a day required to perform the task 2.

D′ is

(R3→T1)+(T1→R3)(R3→T1)+(T1→R3).

D′ is cost information before the task 2 is allocated to the resource 3.

As a result, {C′}-{D′} is

(R3→T2)+(T2→R3)+S2×2.

FIG. 17 is a conceptual diagram of a case where the task 2 is allocated to a resource 4. In FIG. 17, the resource 4 considers that the task 1 has been allocated to a period unit 4 and a period unit 5. The resource 4 is assumed to leave lodging to the place where the task 1 is performed and returns to the lodging on the first day, and when the task 1 ends, returns to the home.

In such a case, the cost information calculating part 29 determines, for example, that the resource 4 leaves the lodging to the place where the task 2 is performed, returns to the lodging on the first day, and when the task 2 ends, heads for the lodging of the place where the task 1 is performed, based on information on the home of the resource 4, information on the place of the task 2, information on the place of the task 1.

Then, the cost information calculating part 29 calculates an increase of cost information when the task 2 is allocated to the resource 4 as

{E′}−{F′}.

Here, E′ is

(R4→T2)+(T2→T1)+(T1→R4)+S1×2+S2×2.

Here, S1 is lodging expenses for a day required to perform the task 1.

F′ is

(R4→T1)+(T1→R4)|S1×2.

F′ is cost information before the task 2 is allocated to the resource 4.

As a result, {E′}−{F′} is

(R4→T2)+(T2→T1)|S2×2−(R4→T1).

The cost information calculating part 29 rounds up an increase of cost information calculated in the abovementioned manner based on a predetermined definition (i.e., make it a rough value by rounding up or rounding down the fractional figure). For example, the cost information calculating part 29 rounds to 0 yen if a calculated increase of cost information is less than 2,500 yen; rounds to 5000 yen if the calculated increase of the cost information is 2500 yen or more and less than 7,500 yen; and rounds to 10,000 yen if the calculated increase of the cost information is 7,500 yen or more and less than 12,500 yen.

The abovementioned definition may be adapted as changeable. That is to say, the cost information calculating part 29 may read files or the like in which the definition is described from the HD 19 or the like and round the increase of cost information based on the definition described in the file. With such a configuration, a user, for example, can change the definition described in the file by manipulating the input device 11 or the like.

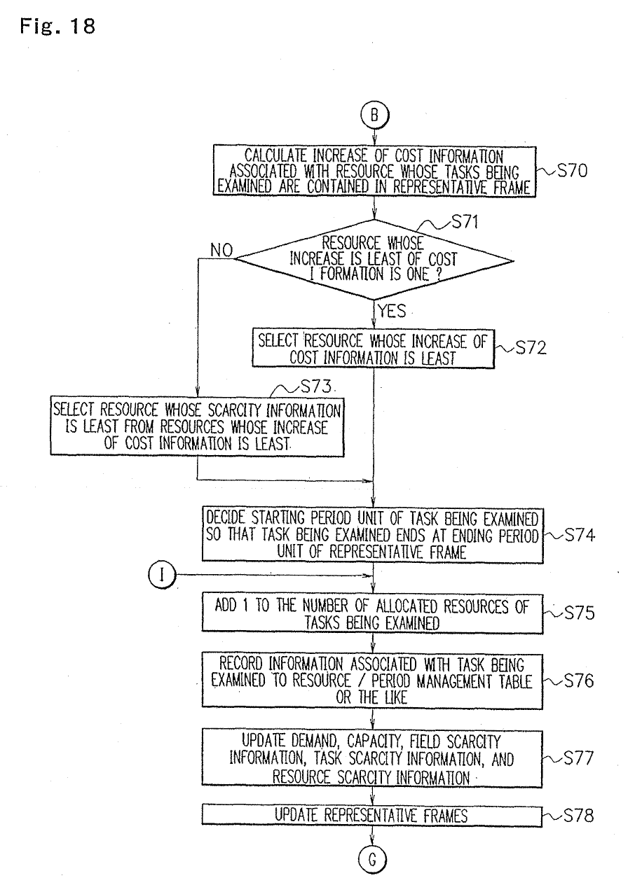

An automatic allocating process of a task in the embodiment will be described by using a flowchart. As the embodiment differs from the first embodiment in a part corresponding to FIG. 9 of the first embodiment, only the part will be described by using FIG. 18.

FIG. 18 is a flowchart (6) showing an automatic allocating process. At the step S70, the cost information calculating part 29 calculates an increase of cost information relating to a resource whose tasks being examined are contained in a representative frame. The cost information calculating part 29 rounds the calculated increase of the cost information as mentioned above.

At the step S71, the resource/period management part 23 determines whether the resource whose increase is the least in the increase of cost information rounded by the cost information calculating part 29 at the step S70 is one or not. If the cost information calculating part 29 determines that the resource whose increase is the least is one (YES at the step S71), the process proceeds to the step S72, and if it determines that the resource whose increased is the least is not one, i.e., multiple (NO at the step S71), the process proceeds to the step S73.

At the step S72, the resource/period management part 23 selects the resource whose increase is the least in the increase of cost information which is rounded by the cost information calculating part 29 at the step S70.

On the other hand, at the step S73, the resource/period management part 23 selects the resource whose scarcity information is the least from the resources whose increase are the least in the increase of cost information rounded by the cost information calculating part 29 at the step S70.

As such, by taking account of an increase of cost information, a resource can be allocated to a task, while cost of transportation expenses, lodging expenses and the like is reduced. By rounding an increase of cost information and taking account of scarcity of a resource, possibility to fail in allocating a resource can be made small. That is to say, a resource can be certainly allocated to a task, while cost is reduced.

As the processes from the step S74 to the step S78 are the same as those from the step S31 to the step S35 shown in the first embodiment, the description of them will be omitted.

In the embodiment, as mentioned above, although it is described to round an increase of cost information, for some types of resource or task, determination at the step S71 may be performed by using an increase of cost information as it is instead of rounding an increase of cost information. In such a case, the determination at the step S71 is YES for almost cases and the process proceeds to the step S72.

### Other embodiments

Although scheduling according to the present invention has been described by taking an example where a resource is considered as an examiner and a task is considered as an examined matter in the abovementioned embodiment, embodiments of the present invention are not limited to that and the embodiment may be used for scheduling where a resource is a home helper and a task is a service (work) provided by the home helper, or may be used for scheduling where a resource is a transporting car and a task is a service (work) provided by the transporting car, for example.

### INDUSTRIAL APPLICABILITY

According to the present invention, a solution space relating to scheduling can be reduced as much as possible. According to the present invention, as a solution space relating to scheduling is reduced, a time for a solution searching process can be reduced.

What is claimed is:

1. A scheduling apparatus comprising:
resource/period management unit managing resource information associated with resources and period information associated with periods consisting of a plurality of period units associated with each other by using a table;
wherein said resource/period management unit executes allocation of a set of said resource information and said period information and a task to be processed based on constraint conditions.

2. The scheduling apparatus according to claim 1, wherein said resource/period management unit obtains a representative frame indicating all or some of said period units which actually can be allocated to the task within said period for each set of said resources, and executes allocation of said representative frame and a task to be processed based on constraint conditions.

3. The scheduling apparatus according to claim 2, wherein said resource/period management unit decides resources which can be allocated to a task to be processed based on execution of said allocation, and decides said period unit starting said task so that the task to be processed ends until said last period unit of said representative frame.

4. The scheduling apparatus according to claim 2, wherein said resource/period management unit updates said representative frame.

5. The scheduling apparatus according to claim 1, further comprising:
task scarcity information calculating unit calculating task scarcity information relating to scarcity of said task;
wherein said resource/period management unit starts said allocation process from the task whose scarcity information is big in unprocessed tasks.

6. The scheduling apparatus according to claim 5, wherein said task scarcity information calculating unit updates said task scarcity information.

7. The scheduling apparatus according to claim 2, further comprising:
resource scarcity information calculating unit calculating resource scarcity information associated with scarcity of said resource;
wherein said resource/period management unit allocates said task to be processed from said representative frame associated with resource whose scarcity information associated with said representative frame is small in said representative frames which can be allocated to a task being examined.

8. The scheduling apparatus according to claim 7, wherein said resource scarcity information calculation unit updates said resource scarcity information.

9. The scheduling apparatus according to claim 2, further comprising cost information calculating unit calculating an increase of cost information when a resource is allocated to a task to be processed;
wherein said resource/period management unit allocates said task to be processed from said representative frame associated with resource in which an increase of said cost information relating to a resource associated with said representative frame is small in said representative frames which can be allocated to said a task to be processed.

10. A scheduling method in a scheduling apparatus wherein it manages resource information associated with resources and period information associated with periods consisting of a plurality of period units associated with each other by using a table, and executes allocation of a set of said resource information and said period information and a task to be processed based on constraint conditions.

11. A computer readable recording medium recording a scheduling program for causing a computer to function as
resource/period management unit managing resource information associated with resources and period information associated with periods consisting of a plurality of period units associated with each other by using a table;
wherein said resource/period management unit executes allocation of a set of said resource information and said period information and a task to be processed based on constraint conditions.
